(19) United States
(12) Patent Application Publication
(10) Pub. No.: US 2005/0174123 A1
(43) Pub. Date: Aug. 11, 2005

(54) Household appliance with a conductivity sensor

(76) Inventor: Elmar Ott, Kressbronn (DE)

Correspondence Address: William D. Breneman, Esq.;BRENEMAN & GEORGES, 3150 Commonwealth Avenue, Alexandria, VA, 22305, US

(21) Appl. No.: 11/034,811

(22) Filed: Jan. 14, 2005

(30) Foreign Application Priority Data
Jan. 16, 2004 (DE) 10 2004 002 647.5

(51) Int. Cl. G01N 27/02

(52) U.S. Cl. 324/439

(57) ABSTRACT

A household appliance, in particular a washing machine, dishwasher or automatic beverage dispenser, with a conductivity sensor for determining the conductivity of a fluid (1) comprising at least two electrodes (2, 3) is proposed, wherein the measuring fluid (1) is prevented from impairing the measuring electrodes (2, 3). This is achieved according to the invention by arranging an electrical insulator (4) between the electrodes (2, 3) of the conductivity sensor and the fluid (1).

The invention relates to a household appliance, in particular a washing machine, dishwasher or automatic beverage dispenser, with a conductivity sensor comprising at least two electrodes for determining the conductivity of a fluid according to the preamble of claim 1.

### PRIOR ART

Household appliances, in particular washing machines, dishwashers or automatic beverage dispensers with a variety of sensors are prior art. For example, dishwashers with integrated water softener encompass sensors for determining the conductivity of the water.

The water softener in these appliances, which generally consists of an ion exchanger, a salt container and a water metering device with air gap, must be set in part manually or automatically to the existing pipe water hardness. EP 901 18 538 discloses a dishwasher with water softener operation controller in which sensors are arranged for measuring the water quality before or after softening.

With respect to conductivity sensors with electrodes extending into the liquid, DE 198 38 688 also discloses that direct contact between the electrodes and fluid or lye can impair the measurement or electrodes. To minimize this occurrence, the electrodes according to this publication are made out of corrosion-resistant material.

### OBJECT AND ADVANTAGES OF THE INVENTION

By contrast, the object of the invention is to propose a household appliance with a conductivity sensor encompassing at least two electrodes, which prevents the measuring fluid from affecting the measuring electrodes.

This object is achieved proceeding from a household appliance of the kind mentioned at the outset by the characterizing features of claim 1.

The measures specified in the subclaims enable advantageous embodiments and further developments of the invention.

A household appliance according to the invention is hence characterized by the fact that an electrical insulator is arranged between the electrodes of the conductivity sensor and the fluid.

It was surprisingly found that capacitive electrodes designed in the correspondingly advantageous manner can be used to generate an analyzable signal according to the invention, despite the electrodes being galvanically separated from the measuring fluid. The insulation is preferably designed as a dielectric of a capacitor, wherein the fluid or measuring medium on the one hand and one of the electrodes on the other form capacitor electrodes facing the dielectric. This completely prevents the measuring fluid, e.g., lye, from impairing the sensor elements or electrodes.

According to the invention, a conductivity or resistance of the fluid connected in series to at least one or two capacitors is determined. A measuring resistor is often used to realize an advantageous voltage divider, with which the analyzable signal is acquired.

In a special further development of the invention, at least one or two electrodes are designed as flat electrodes of a capacitor for the flat formation of the electrode. For example, the flat electrodes are implemented as plates, sheets, jackets, films and/or coatings. This results in electrodes that cover a comparatively large surface, wherein an admittance or impedance measurement is generally improved, for example, as the surface area of the electrode or electrodes increases.

The insulator is advantageously designed at least as part of the wall of a receptacle for the fluid. This step yields a tangible reduction in structural cost. In this variant of the invention, the insulator additionally assumes the function of fluid receptacle. For example, the fluid receptacle can be designed as a supply tank, in particular as a distribution reservoir for the fluid.

As an alternative or in addition to the above, the receptacle can be designed as a flow-through unit that carries the fluid, in particular as a flow element such as a channel or the like. The receptacle is preferably designed at least in part as a pipe. A pipe represents a particularly elegant design for a flow unit according to the invention. If necessary, use can here be made of commercially available pipes, in particular with a round or rectangular cross section. This enables a particularly cost-effective realization of the invention.

In addition, designing the receptacle as a pipe also makes it possible to advantageously make use of household appliance components that might already be present. If necessary, a household appliance conduit can be used in an elegant fashion for the conductivity sensor according to the invention.

The electrodes are advantageously shaped at least in part like a cylindrical jacket. Electrodes designed as a cylindrical jacket are particularly easy to arrange or secure on a pipe wall.

In a special further development of the invention, the two electrodes are situated one after the other and spaced apart in the direction of fluid flow. This advantageous arrangement generates a relatively long measuring path and, if necessary, a largely parallel and relatively dense arrangement of field lines in the area of this measuring path.

At least one cross section of the receptacle or fluid in the separation region is preferably smaller than a cross section of the receptacle or the fluid in the area of one of the two electrodes. This step produces a compression of field lines at least in the separation region, which has a positive influence on the conductivity measurement.

The cross section of the receptacle is often many times smaller in the separation region than the cross section of the receptacle in the area of one of the two electrodes. This enables an especially dense layout of field lines, at least in the separation region.

The sensor is advantageously designed as an impedance sensor or an admittance sensor for determining an impedance or admittance of the fluid. An impedance or admittance, i.e., the apparent share of resistance or admittance, can advantageously be determined and is particularly suitable for further processing or for an advantageous control unit of the household appliance to control and/or regulate the latter.

In general, the conductivity sensor according to the invention can be used for determining the water hardness of freshwater and/or processed soft water coming from an ion exchanger, as well as for other functions relating to the household appliance. For example, the ion exchanger capacity or its charge state and/or a concentration of a rinsing agent or cleanser can also be used to meter the cleanser.

If necessary, the same or at least partially the same components can be used for operating different admittance sensors or conductivity sensors, which are arranged at varying locations for identical or different functions. Such components can include electronic units for acquiring the measured value, e.g., amplifiers or the like, or also computing systems for determining the desired end result from the raw data obtained through measurement.

### EMBODIMENT

An embodiment of the invention is depicted in the drawing, and will be described in greater detail below based on the figures.

Shown in particular are:

FIG. 1 a diagrammatic cross section through a conductivity sensor according to the invention;

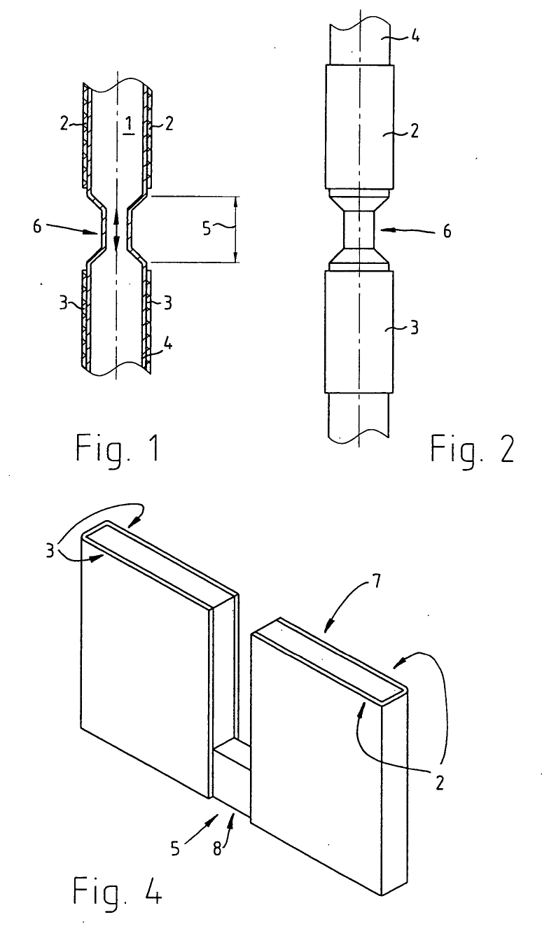

FIG. 2 a diagrammatic top view of the conductivity sensor according to FIG. 1;

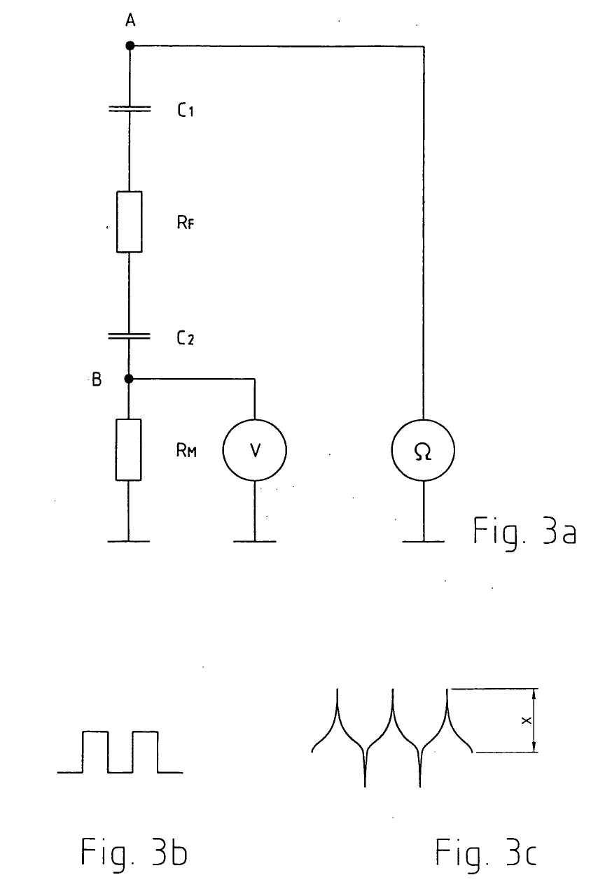

FIG. 3 a diagrammatic equivalent circuit diagram including two voltage progressions for a conductivity sensor according to the invention;

FIG. 4 a diagrammatic perspective view of another conductivity sensor according to the invention;

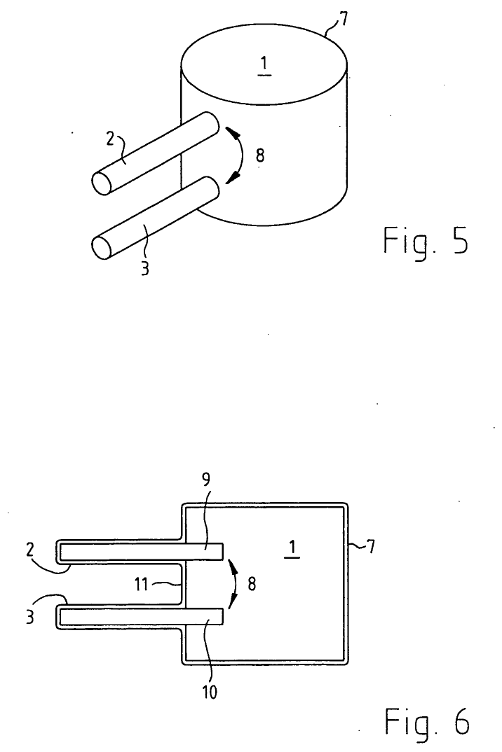

FIG. 5 a diagrammatic perspective view of a third conductivity sensor according to the invention, and

FIG. 6 a diagrammatic cross sectional view through a fourth conductivity sensor according to the invention.

FIG. 1 shows a diagrammatic view of a sensor according to the invention, which is provided with a liquid 1 to determine the conductivity. The sensor includes two flat electrodes 2, 3, which are completely galvanically separated from the liquid 1 by a pipe 4. The pipe 4 is designed as an electrical insulator, in particular made of plastic, ceramic or the like.

Electrodes 2, 3 along with the at least partially conductive liquid 1 and the pipe 4 as a dielectric 4 form electrical capacitors C₁, C₂. The electrodes 2, 3 are each arranged like a cylindrical jacket around the pipe 4, wherein a specific space 5 is present between the two electrodes 2, 3. The pipe 4 has a constriction 6 or contraction 6 in the separation region 5.

FIG. 2 shows a top view of this sensor.

FIG. 3a shows an equivalent circuit diagram of the capacitive impedance measurement according to the invention. FIG. 3b depicts a voltage progression at location A, while FIG. 3c depicts a voltage progression at location B of the equivalent circuit diagram. FIG. 3b illustrates that a square-wave voltage can be applied, e.g., measuring about 40 kHz and 5 V (3.3 V). In principle, other voltage waveforms and frequencies are also possible.

The two capacitors C₁ and C₂ and a variable resistor R_{F} of fluid 1 or a measuring resistor R_{M}, e.g., from 3.3 to 10 kΩ, apply a voltage according to FIG. 3c to location B. It has been shown that a voltage drop at the measuring resistor R_{M} is proportional to the conductance of the liquid 1, wherein a nearly linear behavior of the corresponding characteristic curve exists over a wide area. This can be used to advantage for determining the conductivity and controlling or regulating the household appliance according to the invention.

FIG. 4 shows another variant of the conductivity sensor according to the invention, wherein identical reference numbers denote the same components. In this variant, the two electrodes 2, 3 are placed directly opposite the medium or liquid 1 of the container 7 as essentially U-shaped plates 2, 3. A narrowing or constriction 6 of the cross section of the liquid 1 is again provided between the two electrodes in the separation region 5. In this variant of the invention, this area forms the essential part of a measurement interval 8.

In the variant of the invention shown on FIG. 5, the two electrodes 2 and 3 are each wound around pipes as a cylindrical jacket, wherein the liquid 1 is present inside the pipes. In the area of the pipes, the liquid 1 is essentially designed to route the signal into a measuring chamber 7 or to a measurement interval 8.

FIG. 6 shows another variant of the invention, featuring a diagrammatic sectional view of an arrangement comparable with the device according to FIG. 5. As opposed to the variant according to FIG. 5, however, this variant has auxiliary electrodes 5 and 10, which are fixed inside the arrangement or pipes. The electrodes 2, 3 in this case are completely galvanically separated from the auxiliary electrodes 9 and 10 by the wall of the container 7. The auxiliary electrodes 9, 10 are in direct contact with the liquid 1, wherein these 9, 10 guide the signal from the electrodes 2, 3 to the measurement interval 8, which especially shapes the measuring signal.

In general, the invention makes it possible to acquire both the conductivity of flowing and motionless media 1 in receptacles 4, 7.

### REFERENCE LIST

1 Liquid
2 Electrode
3 Electrode
4 Pipe
5 Separation
6 Constriction
7 Container
8 Measurement interval
9 Auxiliary electrode
10 Auxiliary electrode
11 Wall
A Location
B Location
C_{1,2} Capacitor
R_{F,M} Resistor

1. A household appliance, in particular washing machine, dishwasher or automatic beverage dispenser, with a conductivity sensor for determining the conductivity of a fluid (1) with at least two electrodes (2, 3), characterized in that an electrical insulator (4, 7) is arranged between the electrodes (2, 3) of the conductivity sensor and the fluid (1).

2. The household appliance according to claim 1, characterized in that at least one of the electrodes (2, 3) is designed as a flat electrode (2, 3) of a capacitor (C₁, C₂) for the flat formation of the electrode (2, 3).

3. The household appliance according to one of the preceding claims, characterized in that at least two electrodes (2, 3) are designed as flat electrodes (2, 3) of the capacitor (C₁, C₂).

4. The household appliance according to one of the preceding claims, characterized in that the insulator (4, 7) is designed at least as part of the wall (4, 7) of a receptacle (4, 7) for the fluid (1).

5. The household appliance according to one of the preceding claims, characterized in that the receptacle (4, 7) is designed at least partially as a pipe (4).

6. The household appliance according to one of the preceding claims, characterized in that the electrodes (2, 3) are shaped at least in part like a cylindrical jacket.

7. The household appliance according to one of the preceding claims, characterized in that the two electrodes (2, 3) are situated one after the other in the direction of flow of the fluid (1) and with a separation (5) between them.

8. The household appliance according to one of the preceding claims, characterized in that at least one cross section of the receptacle (4, 7) in the separation region (5) is smaller than a cross section of the receptacle (4, 7) fluid in the area of one of the two electrodes (2, 3).

9. The household appliance according to one of the preceding claims, characterized in that the cross section of the receptacle (4, 7) is many times smaller in the separation region (5) than the cross section of the receptacle (4, 7) in the area of one of the two electrodes (2, 3).

10. The household appliance according to one of the preceding claims, characterized in that the conductivity sensor is designed as an impedance sensor or an admittance sensor for determining an impedance or admittance of the fluid (1).
